(19) United States
(12) Patent Application Publication
(10) Pub. No.: US 2023/0259960 A1
(43) Pub. Date: Aug. 17, 2023

(54) METHOD FOR CONDUCTING ONLINE OPINION POLLS BY A SYSTEM

(71) Applicant: YIFTACH HARRIS, RISHON LEZION (IL)

(72) Inventor: YIFTACH HARRIS, RISHON LEZION (IL)

(21) Appl. No.: 17/670,537

(22) Filed: Feb. 14, 2022

(51) Int. Cl. G06Q 30/02; G06F 40/18

(52) U.S. Cl. CPC G06Q 30/0203; G06Q 30/0201; G06Q 30/0217; G06F 40/18

(57) ABSTRACT

A method for conducting online opinion polls, the method including a poll registration stage, a poll definition stage, a poll distribution stage, a questionnaires elimination stage, a statistical analysis stage, a dispatching stage, and a remuneration stage comprising the steps of remunerating each respondent of the poll, and remunerating the system, where the remuneration of a respondent for participating the poll is in a form of a coupon sent to a residence of the respondent, thereby allowing detecting unreliable users such that if each registered user is authenticated, then if the same user is registered several times, his reliability is downgraded, and the system will stop offering him to participate in their polls.

### FIELD

The invention relates generally to the field of conducting online opinion polls.

### BACKGROUND

“An opinion poll, often simply referred to as a poll or a survey, is a human research survey of public opinion from a particular sample. Opinion polls are usually designed to represent the opinions of a population by conducting a series of questions and then extrapolating generalities in ratio or within confidence intervals.” (From Wikipedia)

US 2013/0339091 describes a method for conducting “a targeted polling and creating, responding, managing, publishing, socializing, and/or commercializing targeted polls using a variety of media such as mobile applications, the web, and/or other communication media. In one aspect, the disclosed subject matter facilitates allowing mobile users to respond to and/or promulgate polls. As further advantages, embodiments of the disclosed subject matter allow polls to be created, responded to, published, shared, managed, and/or analyzed within a social polling platform.”

Unlike a traditional survey which is based on preliminary information of what kind of population a respondent represents, an online opinion poll does not necessarily have preliminary information about the population that each of the respondents represents. Therefore, at least the credibility of each respondent must be assessed.

All the methods described above have not yet provided satisfactory solutions to the problem of conducting online opinion polls.

### SUMMARY

In one aspect, the invention is directed to a method for conducting online opinion polls, the method including the stages of a poll registration stage including the steps of ordering by a customer from the system a conduction of a poll, a poll definition stage including the steps of conducting a poll by (a) setting a respondent population of the poll, (b) setting a questionnaire of the poll, and (c) setting at least one distribution channel of the poll, a poll distribution stage including the steps of (a) offering users through the selected distribution channels to participate in the poll, (b) waiting a period in which users are allowed to participate the poll by filling the questionnaire, a questionnaires elimination stage including the steps of (a) rating a reliability of each filled questionnaire by checking consistency of responses to questions of the questionnaire, and (b) eliminating each filled questionnaire having a reliability rate lower than a predetermined threshold, a statistical analysis stage including the step of statistically analyzing of remained questionnaires after the elimination stage, a dispatching stage including the step of sending to the customer (a) conclusions of the statistical analysis and (b) a spreadsheet of responses of the remained questionnaires, for allowing further statistical analysis, and a remuneration stage including the steps of remunerating each respondent of the poll, and remunerating the system.

Preferably, the consistency of responses is determined by at least two identical responses to a repeated question of the questionnaire.

A question of the questionnaire may be of a YES/NO question, of an inverse YES/NO question, of a multiple answers question, etc.

Preferably, the remuneration of a respondent for participating the poll is in a form of a coupon sent to a residence of the respondent, thereby allowing detecting unreliable users. For example, assuming each registered user is authenticated, then if the same user is registered several times, his reliability is downgraded, and the system will stop offering him to participate in their polls.

Nevertheless, the remuneration may be also in a financial form.

As mentioned, in rating a reliability of a questionnaire a reliability rate of a respondent of the questionnaire can be taken in consideration. For example, on the assumption that a reliability rating is between 0.0 and 1.0 where 0.0 is the lowest value, a weighted questionnaire rating will be the questionnaire's rating multiplied by the user's reliability rating.

Preferably, a rate of a user is affected by a rate of each questionnaire he fills.

According to one embodiment of the invention, the setting of the respondent population includes only registered users of the system.

According to one embodiment of the invention, the setting of the respondent population includes registered and non-registered users of the system.

According to one embodiment of the invention, the at least one distribution channel includes an email message to each of the users.

According to one embodiment of the invention, the at least one distribution channel includes a text message to a smartphone of each of the users.

According to one embodiment of the invention, the at least one distribution channel includes viral distribution via addressees of an address book of a smartphone of the user.

According to one embodiment of the invention, the at least one distribution channel includes viral distribution via friends of the user in a social network.

According to one embodiment of the invention, the at least one distribution channel includes advertising in at least one social network.

According to one embodiment of the invention, the at least one distribution channel includes advertising in press and websites. A distribution in press can include a QR code and the like, that upon scanning thereof directs a browser to the web site of the poll.

The method may further include a preliminary stage including authenticating each of the users during registration to the system, thereby allowing detecting users that fill multiple questionnaires of said poll. The authentication may be carried out also before letting a participant to fill a questionnaire. The authentication may be carried out, for example, via biometric samples.

The foregoing embodiments of the invention have been described and illustrated in conjunction with systems and methods thereof, which are meant to be merely illustrative, and not limiting.

According to one embodiment of the invention, a response time to a question of a questionnaire affects a reliability rating of said questionnaire. For example, a “long” average response period indicates that the respondent has referred to the questions asked, while a “short” average response indicates that the respondent has provided random responses (fake answers).

### BRIEF DESCRIPTION OF THE DRAWINGS

Embodiments, features, and aspects of the invention are described herein in conjunction with the following drawings, in which:

FIG. 1 schematically illustrates a data flow in a registration process to a system for conducting online opinion polls, according to one embodiment of the invention;

FIG. 2 is a flowchart of a process of registering a poll, according to one embodiment of the invention;

FIG. 3 is a flowchart of a process of conducting a poll, according to one embodiment of the invention;

FIG. 4 is a flowchart of a process of eliminating an unreliable questionnaire, according to one embodiment of the invention;

FIG. 5 is a flowchart of a process of rating a reliability of a questionnaire, according to one embodiment of the invention; and

FIG. 6 is a distribution chart of a poll, according to embodiments of the invention.

It should be understood that the drawings are not necessarily drawn to scale.

### DETAILED DESCRIPTION

The invention will be understood from the following detailed description of embodiments, which are meant to be descriptive and not limiting. For the sake of brevity, some well-known features, methods, systems, procedures, components, circuits, and so on, are not described in detail.

In the description herein, the following terms are defined:

A “user” (subscriber) is a person that can be registered as a respondent of a poll.

A “customer” is a person (business entity, etc.) that orders conduction of a poll.

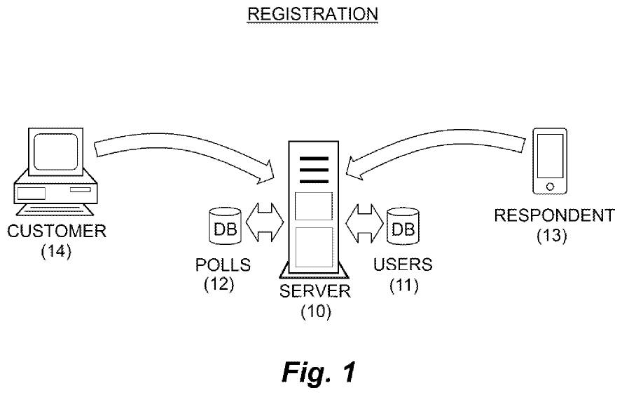

FIG. 1 schematically illustrates a data flow in a registration process to a system for conducting online opinion polls, according to one embodiment of the invention.

A server 10 conducts the survey activities. It is the entity that concentrates the activities regarding each poll. The registration of users in the users' database 11 is carried out via the server, and also registrations of orders for conducting polls in the polls database 12 is carried out via the server 10. Assessment of a reliability of the questionnaires of the respondents is/can be carried out by the server, and also the output of the polls is carried out by the server. Thus, the server 10 is actually a computer that concentrates the computing activity of conducting polls. Of course, a “server” may be a plurality of computers, such as a server farm.

Users, i.e., potential respondents, are registered in a preliminary procedure in a database of users 11. After the registration, each of the users may be a participant in the polls.

In order to register to the system as a respondent, a user is asked to provide bibliographic questions such as age, email address, occupation, address, gender, profession, fields of interest, etc. In addition, each of the users is asked questions through which his credibility can be assessed. For example, the user may be asked the same question several times, and if his answers are not consistent, the credibility rate he gets is negatively affected. Another technique for assessing a reliability of the answers of a respondent is asking the same question in different phrasings.

A customer orders conduction of a poll through a terminal 14, such as a computer, a smartphone, etc., which is connected to the server via, for example, the internet. The poll is registered in a polls database 12. In the registration process the customer must define the questions of the poll, characteristics of the respondents (age range, geographical location, gender, etc.), etc. He also has to define the number of respondents and the sum to be paid to each respondent. The poll company (i.e., that owns the server) gets a share from these amounts, for example 10%.

As illustrated in the figure, the databases 11 and 12 are in data communication with the server. Preferably, the data communication between the server and the databases is wired, e.g., on the same bus, network, etc. As per the terminals 13 and 14, since usually they are remote to the server, they can access the server via a network, such as the Internet.

The terminals may be in a form of a computer, smartphones, etc., executing a software application or browsing a certain web site.

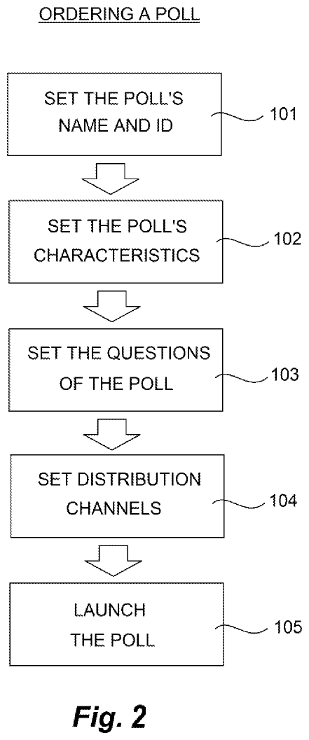

FIG. 2 is a flowchart of a process of registering a poll, according to one embodiment of the invention.

In step 101, a customer gets in contact with the poll server via his smartphone, a computer connected to the internet, etc. He determines the poll's name, and optionally a poll ID, which is used for distinguishing one poll from other polls, which is required especially when a poll is repeated each predetermined period, such as four months.

In step 102, the customer sets the poll's characteristics, such as the age of the respondents, the number of respondents, the cost to be paid for each respondent, etc. For example, 400 participants, $0.35 per each, age between 16 and 18.

In step 103, the customer determines the questions to be asked in the poll. Each question may include one or more audio files, stills files, and video files. The questions may be in a form of an option bar (i.e., the respondent may respond by one or more options), a rate, etc.

Of course, the system has to allow a customer to return to each stage and amend the definitions, such as adding or removing questions, answering options, etc.

In step 104, the customer defines the distribution characteristics such as the distribution channels, the population of the poll (i.e., how to inform the users about the new poll), etc. The distribution may be via the email of each user, a text message to his smartphone, advertising in social networks, etc. Then the customer determines whether to allow only registered users to be respondents of the poll, or to open the participation to anyone.

After all the polls' parameters have been defined, in step 105, the poll is “launched”.

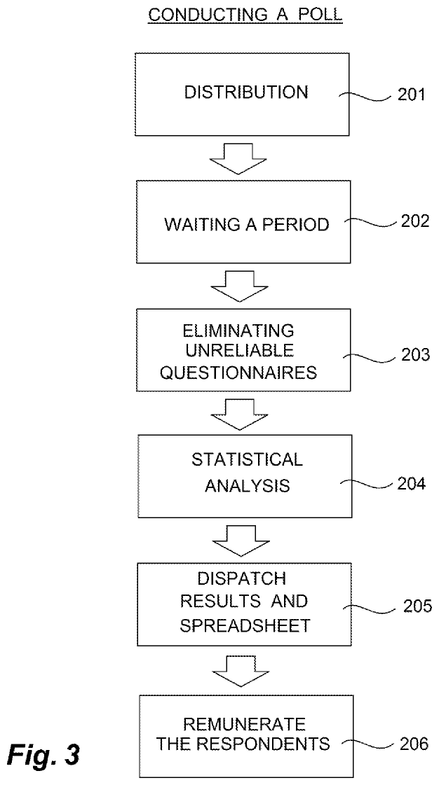

FIG. 3 is a flowchart of a process of conducting a poll, according to one embodiment of the invention.

In step 201, the poll is distributed to the users that might be interested participating in the poll. For example, the poll may be directed to users of a certain range of ages. Another example is fields of interest, such as food products, local politics, global politics, etc. The distribution can be carried out by email, text messages, etc.

In step 202, no action is taken during a predetermined period. The purpose is to allow participants to respond a questionnaire during this period. The period can be prolonged or shortened, according to the number of participants. If lesser participants than defined have participated, then the period can be prolonged, and vice versa.

Preferably, a questionnaire is filled out by browsing a web site, or by an application (program) executed by a smartphone or computer of a respondent. Of course other forms can also be used.

In step 203, the unreliable questionnaires are eliminated, thereby increasing the reliability of the poll. The reliability can be determined not only by the reliability of the responses to the poll's questionnaire, but also by the reliability of each user.

According to one embodiment of the invention, the respondents can be also non-registered users. Opening a participation in a poll to non-registered users may increase the number of participants, especially when the number of participants is lesser than required according to the poll's definition. Also, some polls may be directed to occasional participants rather than to registered users.

A questionnaire can be detected as unreliable during its filling. In this case, the system may abort the questionnaire, and inform the respondent about this.

In step 204, a statistical analysis is carried out on the questionnaires of the poll.

In step 205, the statistical conclusions of the poll are sent to the customer. This can include also spreadsheets with the questionnaire replies, in order to allow refining the statistical analysis.

In step 206, the respondents of the poll are remunerated. For convenience reasons, the remuneration may be financial. However, preferably the remuneration is in a form of a gift, such as a printed coupon, for preventing from a user to be registered in the opinion poll system a plurality of times, since a user has usually a single address. The coupon can be, for example, a cup of coffee in a coffee network.

In addition to remuneration of the respondents, the poll company, i.e., the one that owns the server, can be remunerated at this stage, e.g., by a percentage of the charge per each user. The poll company may be remunerated, at least by an advance, at the poll registration stage, and with rest when the poll conducting ends.

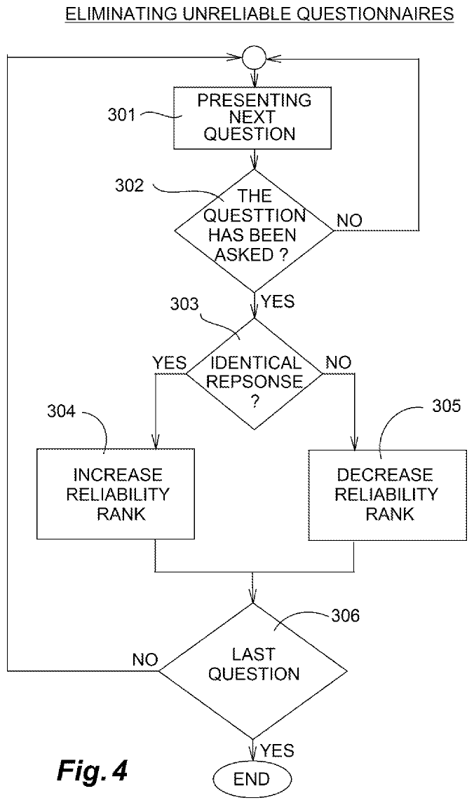

FIG. 4 is a flowchart of a process of eliminating an unreliable questionnaire, according to one embodiment of the invention.

The questions of a questionnaire may be displayed to a respondent in a sequent order, although the questions can be asked in random. In addition to a textual question, a figure and/or a video clip can accompany the text. Of course, the questions may be asked in an audio form as a substitute or addition to the text.

One of the obstacles an online system for conducting opinion polls is facing is rating the reliability of a questionnaire, and more particularly sifting out unreliable questionnaires, since a respondent may be distracted when filling a questionnaire and even participating in a poll because of the remuneration.

In block 301, the next question is presented to the respondent on the display of his terminal.

From the next block 302, if the question has not been asked previously, the flow continues with block 301, otherwise the flow continues with block 303.

From block 303, if the respondent response to the present question is the same as responded to previous instant(s) of this question(s) then the flow continues with block 304 where the reliability rate of the questionnaire is increased; and if the response to this question is different than previous instance(s) of the question(s) then the flow continues with block 305 where the reliability rate of the questionnaire is increased.

From the next block 306, if this was not the last question, then the flow returns to block 301, otherwise the process ends.

For example, each time the respondent answers to a certain question the same answer, his reliability rate is increased by 1, and vice versa.

The questions that can be asked may be divided, for example, to three types: a YES/NO question, an inverse YES/NO question, and a multiple answers question.

An example of a YES/NO question may be: do you like the product?

An example of an inverse YES/NO question may be: do you dislike the product? Thus, it is the same question as a YES/NO question, but phrased in an inverse form, and the answer also has to be negative.

An example of a multiple answers question may be: What color of the product you prefer: Black, white, green or orange?

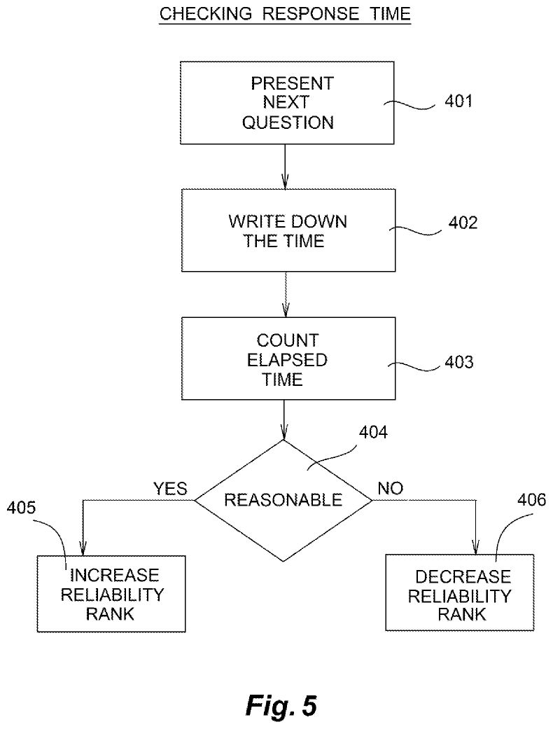

FIG. 5 is a flowchart of a process of rating a reliability of a questionnaire, according to one embodiment of the invention.

In step 401, the question is presented to the respondent.

In the next step 402, the presentation time is written down.

In the next step 403, which takes place after the response to the question has been dispatched the time elapsed from the presentation to the response dispatch is counted.

From step 404, is the response time is reasonable, then flow continues with step 404 where the reliability rate is increased; otherwise flow continues to step 406 where the reliability rate is decreased.

A reasonable response time can be counted, for example, by the time required to read the question (in the case of textual question), and expected time to respond the question.

The methods described and illustrated in FIGS. 4 and 5 are intended to examine if the respondent does tries to answer the questions, and does not fake because of initial intent, lack of concentration, etc.

From time to time, the respondent will be asked to prove that he is not a robot. Nowadays these techniques are common.

Furthermore, in a random moment during the response of a questionnaire, the identity of the respondent can be authenticated, e.g., by a biometric sample such as a fingerprint.

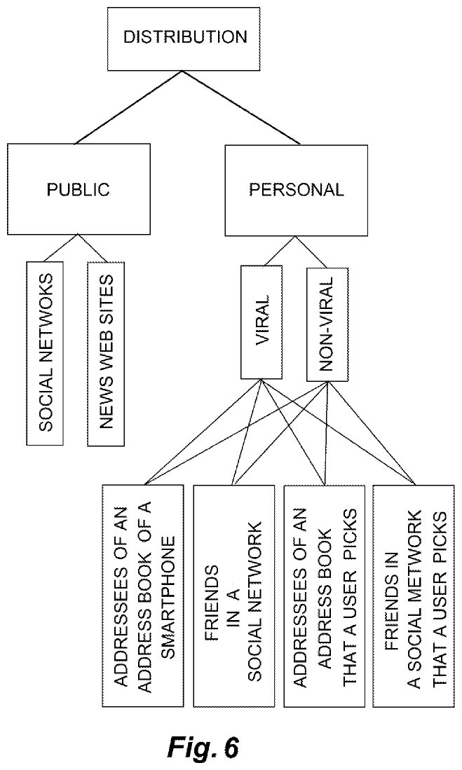

FIG. 6 is a distribution chart of a poll, according to embodiments of the invention.

The distribution forms can be divided into two categories: public and personal. The public form includes press, web sites, etc.

The personal form can be divided into two categories: viral and non-viral. For example, a user may distribute to each of the addresses of an address book of his smartphone that currently a poll is taking place, and he may participate in. Each of the addresses may also do the same, so the distribution is “viral”.

For example, the following ways may be used as a source for personal distribution: addressees of an address book of a smartphone of a user, “friends” in a social network the user is a participant of, addressees that a user picks from his address book, friends of a social network the user picks.

Of course there are merely examples, and other distribution planes can be used.

In the figures and/or description herein, the following reference numbers (Reference Signs List) have been mentioned:

numeral 10 denotes a polls server;

numeral 11 denotes users (respondents) database;

numeral 12 denotes a polls database;

numeral 13 denotes a user (respondent) terminal; and

numeral 14 denotes a poll order terminal.

The foregoing description and illustrations of the embodiments of the invention have been presented for the purposes of illustration. It is not intended to be exhaustive or to limit the invention to the above description in any form.

Any term that has been defined above and used in the claims, should to be interpreted according to this definition.

What is claimed is:

1. A method for conducting an online opinion poll by a system, the method comprising the stages of:
a poll registration stage comprising the steps of: ordering by a customer from said system a conduction of a poll;
a poll definition stage comprising the steps of: conducting a poll by (a) setting a respondent population of said poll, (b) setting a questionnaire of said poll, and (c) setting at least one distribution channel of said poll;
a poll distribution stage comprising the steps of: (a) offering users through the selected distribution channels to participate in said poll, (b) waiting a period in which users are allowed to participate said poll by filling said questionnaire;
a questionnaires elimination stage comprising the steps of: (a) rating a reliability of each filled questionnaire by checking consistency of responses to questions of said questionnaire, and (b) eliminating each filled questionnaire having a reliability rate lower than a predetermined threshold;
a statistical analysis stage comprising the step of: statistically analyzing of remained questionnaires after said elimination stage;
a dispatching stage comprising the step of: sending to said customer (a) conclusions of said statistical analysis and (b) a spreadsheet of responses of said remained questionnaires, for allowing further statistical analysis; and
a remuneration stage comprising the steps of: remunerating each respondent of said poll, and remunerating said system.

2. A method according to claim 1, wherein said consistency of responses is determined by at least two identical responses to a repeated question of said questionnaire.

3. A method according to claim 1, wherein said consistency of responses is determined by an identical response to an inverse question.

4. A method according to claim 1, wherein each of said questions is of a type selected from a group consisting of: a YES/NO question, an inverse YES/NO question and a multiple answers question.

5. A method according to claim 1, wherein a remuneration of a respondent for participating said poll is in a form of a coupon sent to a residence of said respondent, thereby allowing detecting unreliable users.

6. A method according to claim 1, wherein remuneration to a respondent is in a financial form.

7. A method according to claim 1, wherein in rating a reliability of a questionnaire is taken in consideration a reliability rate of a respondent of said questionnaire.

8. A method according to claim 1, wherein a rate of a user is affected by a rate of each questionnaire he fills.

9. A method according to claim 1, wherein said setting a respondent population includes only registered users of said system.

10. A method according to claim 1, wherein said setting a respondent population includes registered and non-registered users of said system.

11. A method according to claim 1, wherein said at least one distribution channel includes an email message to each of said users.

12. A method according to claim 1, wherein said at least one distribution channel includes a text message to a smartphone of each of said users.

13. A method according to claim 1, wherein said at least one distribution channel includes viral distribution via addressees of an address book of a smartphone of said user.

14. A method according to claim 1, wherein said at least one distribution channel includes viral distribution via friends of said user in a social network.

15. A method according to claim 1, wherein said at least one distribution channel includes advertising in at least one social network.

16. A method according to claim 1, wherein said at least one distribution channel includes advertising in press and websites.

17. A method according to claim 1, further comprising a preliminary stage comprising: authenticating each of said users during registration to said system, thereby allowing detecting users that fill multiple questionnaires of said poll.

18. A method according to claim 1, further comprising a preliminary stage comprising: authenticating each of said users before filling a questionnaire, thereby allowing detecting users that fill multiple questionnaires of said poll.

19. A method according to claim 17, wherein said authenticating is carried out via a biometric sample.

20. A method according to claim 18, wherein said authenticating is carried out via biometric sample.

21. A method according to claim 1, wherein a response time to a question of a questionnaire affects a reliability rating of said questionnaire.
